(19) United States
(12) Patent Application Publication
(10) Pub. No.: US 2011/0058048 A1
(43) Pub. Date: Mar. 10, 2011

(54) APPARATUS, METHOD AND SYSTEM FOR COLLECTING AND UTILIZING DIGITAL EVIDENCE

(75) Inventors: Gidon Elazar, Kibutz Einat (IL); Dan Harkabi, Kibutz Einat (IL)

(73) Assignee: Picosmos IL, Ltd.

(21) Appl. No.: 12/713,986

(22) Filed: Feb. 26, 2010

Related U.S. Application Data
(60) Provisional application No. 61/155,915, filed on Feb. 27, 2009.
(60) Provisional application No. 61/161,780, filed on Mar. 20, 2009.

(51) Int. Cl. H04N 5/225; H04N 5/76

(52) U.S. Cl. 348/207.1; 348/231.99; 348/231.4; 348/E05.024

(57) ABSTRACT

A handy, low cost, tamper-evident evidence recording device is disclosed. A method and system for utilizing evidence recording devices in improving various business processes such as insurance claims processing, car and equipment rentals, and property leases disputes, is disclosed.

### CROSS REFERENCE TO RELATED APPLICATIONS

This application claims priority to U.S. Provisional Application No. 61/155,915 filed Feb. 27, 2009, and U.S. Provisional Application No. 61/161,780 filed Mar. 20, 2009, the entire disclosures of which are incorporated herein by reference.

### FIELD OF THE INVENTION

The present invention pertains to the field of legal evidence. More particularly, the invention pertains to utilizing a low cost, tamper evident audio-visual recording device to record events for the purpose of serving as evidence for insurance and other legal purposes.

### BACKGROUND OF THE INVENTION

### Advances in Digital Cameras

Modern digital cameras have become a mass consumer product over the last decade.

Technology advances, the low bill of materials, and mass production have made both digital still cameras and digital video cameras so cheap that they are implemented as modules within other consumer electronic devices such as mobile phones (Nokia N95) and MP3 players (iPod Touch). The miniaturization of various elements of a digital camera is limited today mostly by human interface considerations, and not technical issues.

Prices have dramatically decreased for various components of digital cameras, for example the optic sensor costs only a few dollars. Flash memory capable of storing several hundreds of photos also costs only a few dollars. Write once memory (cannot be edited or deleted) is even cheaper.

As a result, some manufacturers are building and selling one-time disposable digital cameras. For example, PureDigital Inc. (www.Puredigitalinc.com) manufactures disposable digital cameras and camcorders. Digital cameras are sold for as low as $20.00 online, in convenience stores and drugstores such as CVS (http://www.cvs.com/CVSApp/catalog/shop_product_detail.jsp?filterBy=&skuId=274180&productId=274180&navAction=jump&navCount=3), and other places. A website dedicated to disposable digital cameras (http://www.disposabledigitalcameras.org/) offers a disposable digital camera, with a 100 k CMOS sensor and 16 MB of memory for $15.00 (http://www.disposabledigitalcameras.org/index.asp?PageAction=VIEWPROD&ProdID=156).

### Insurance Basics

Insurance is defined as the equitable transfer of the risk of a loss, from one entity to another, in exchange for a premium, and can be thought of as a guaranteed small loss to prevent a large, possibly devastating loss. An insurance company (hereafter: insurer, insurance provider, or insurance company) sells insurance to a consumer who is then insured (hereafter: policyholder, customer, end-user, or insured). The amount charged by the insurer for insurance coverage is called the premium.

Insurance agents (hereafter: agents) usually work for or are contracted directly by insurance companies to sell insurance policies. Insurance brokers (hereafter: brokers) may or may not have regular direct contact with an insurance company and generally survey a number of companies to get the best policy to their customer.

Vehicle insurance, also known as auto insurance, car insurance, or motor insurance (hereafter: auto insurance) is insurance purchased for cars, trucks, motorcycles and other vehicles. Its primary use is to provide protection against losses incurred as a result of traffic accidents and against liability to third parties that could be incurred in an accident.

Auto insurance protects its policyholder against financial loss in case of an accident or other damage. It is a legal contract between the policyholder and the insurance company. There are 3 main categories of auto insurance coverage: property, liability and medical coverage.

Property coverage pays for damage to or theft of a vehicle. It may further be divided to collision coverage and comprehensive coverage. Collision coverage provides coverage for an insured's vehicle that is involved in an accident, subject to a deductible. This coverage is designed to provide payments to repair the damaged vehicle, or payment of the cash value of the vehicle if it is not repairable. Collision coverage is optional. Collision Damage Waiver (CDW) or Loss Damage Waiver (LDW) is the term used by rental car companies for collision coverage.

Comprehensive coverage provides coverage for an insured's vehicle that is damaged by incidents that are not considered collisions. For example, fire, theft (or attempted theft), vandalism, weather, or impacts with animals are types of comprehensive losses.

Liability coverage pays for a policyholder's legal responsibility to others for bodily injury or property damage. Liability coverage is offered for events in which the insured driver is deemed responsible.

Medical coverage pays for the cost of treating injuries, rehabilitation and, sometimes, lost wages and funeral expenses.

The deductible (US) or excess (UK) is the portion of any claim that is not covered by the insurance company. It is the amount of expenses that must be paid out of pocket by the policyholder before an insurer will cover any expenses. The payment of the deductable may be made directly to the repair shop.

In a typical auto insurance policy, a deductible will apply to claims arising from damage to or loss of the policyholder's own vehicle, whether this damage/loss is caused by accidents for which the holder is responsible, or vandalism and theft. Third-party liability coverage generally has no deductible, since the third party will likely attempt to recover any loss, however small, for which the policyholder is liable.

If an accident was the fault of a third party (for example, the driver of the other car), and this is accepted by the third party's insurer, a policyholder will be able to reclaim the deductable payment from the third party's insurance company.

Claims as well as loss handling are the actual “product” paid for by a policyholder to the insurance company. A policyholder may file claims directly with the insurer or through brokers or agents. The insurer may require that the claim be filed on its own proprietary forms, or may accept claims on a standard industry form such as those produced by ACORD (Association for Cooperative Operations Research and Development, the insurance industry's nonprofit standards developer).

Insurance company claim departments employ a large number of claims adjusters supported by a staff of records management and data entry clerks. Incoming claims are classified based on severity and are assigned to claims adjusters whose settlement authority varies with their knowledge and experience.

The claims adjuster completes an investigation of each claim, usually in close cooperation with the policyholder, determines a monetary value, and authorizes payment. In the case of an automobile accident, the payment covers damage to the vehicle and medical bills, if any.

Adjusting liability insurance claims is more challenging because there is a third party involved, under no contractual obligation to cooperate with the insurer, that would like to receive as high a payment as possible. Usually the third party executes this process through his or her own insurance company. In many cases, it is difficult for the insurer to ascertain the correct details of the damages to the third party.

### Insurance Fraud

Claims management requires balancing customer satisfaction, administrative handling expenses, and claims overpayment leakages. Unfortunately, fraudulent insurance practices are a major business risk that must be managed and overcome. Sometimes disputes between insurers and policyholders over the validity of claims or claims handling practices escalate into litigation.

Insurance fraud is any act committed with the intent to fraudulently obtain payment from an insurer. Fraudulent claims account for a significant portion of all claims received by insurers, and cost billions of dollars annually. Types of insurance fraud are very diverse, and occur in all areas of insurance.

Insurance fraud ranges in severity, from slightly exaggerating claims to deliberately causing accidents or damage. Insurance fraud poses a significant problem, so much so that governments and other organizations are making efforts to deter such activities.

For example, in the US, insurance fraud is specifically classified as a crime in 48 out of the 50 states. 19 states require mandatory insurer fraud plans. This requires companies to form programs to combat fraud and in some cases to develop investigation units to detect fraud. 41 states have fraud bureaus.

It is hard to know the exact extent of financial damage caused by fraudulent insurance claims. The Coalition Against Insurance Fraud estimates that in 2006 a total of about $80 billion was lost in the United States due to insurance fraud. Other insurance industry experts claim fraud accounts for 10% of claims, approximately $100 billion a year. Insurers say they spend $650 million annually just in fraud detection, not counting the losses incurred (http://www.forbes.com/2003/09/22/cz_wb_{—}0922fraud.html)

Insurance fraud can be classified as either hard fraud or soft fraud. Hard fraud occurs when someone deliberately plans or invents a loss, such as a collision, auto theft, or fire that is covered by their insurance policy in order to receive payment for damages.

Soft fraud, which is far more common than hard fraud, is sometimes also referred to as opportunistic fraud. This type of fraud consists of policyholders exaggerating otherwise legitimate claims. For example, when involved in a collision, a policyholder might claim more auto damage than was really sustained. Soft fraud may also occur when, while obtaining a new insurance policy, an individual misreports previous or existing conditions in order to obtain a lower premium on their insurance policy. A typical example of soft auto insurance fraud is reporting higher costs for car repairs than those that were actually incurred. Sometimes damages from an unrelated incident, such as a previous accident, are added to the claim. Once an exaggerated claim is identified, insurance companies usually try to negotiate the claim down to the appropriate amount.

The detection of insurance fraud generally occurs in two steps. The first step is to identify suspicious claims that have a higher possibility of being fraudulent. This can be done by computerized statistical analysis or by referrals from claims adjusters or insurance agents. The next step is to refer these claims to investigators for further analysis.

Insurance companies use statistical analysis to identify suspicious claims for further investigation.

Suspicious claims can also be submitted to “special investigative units”, or SIUs, for further investigation. These units generally consist of experienced claims adjusters with special training in investigating fraudulent claims. These investigators look for certain symptoms associated with fraudulent claims, or otherwise look for evidence of falsification of some kind. This evidence can then be used to deny payment of the claims or to prosecute fraudsters if the violation is serious enough.

As a result of insurance fraud over the years, insurance companies have had to raise the price of insurance policies for all policyholders. Thus, the cost of insurance fraud is ultimately distributed among many honest consumers.

In addition, the vast amount of fraudulent claims has made insurance companies suspicious of all policyholders, even honest ones. This in return causes honest customers to feel that they are receiving unfair treatment or that their claim processing is being unduly dragged. This creates a demonization of insurance companies and the insurance industry in general in many people's minds. Needless to say, fraud has created an inherent strain in the relationship of insurers and insured.

### Digital Photos Use as Evidence

Digital photos and videos have become an integral part of people's lives and have supplanted printed photos for various uses. In legal proceedings, digital photos are admissible as evidence, according to US Federal Rules of Evidence. As with all items submitted for evidence in a court of law, digital photos must be authentic and identifiable.

The process of linking a piece of evidence to a case, of authenticating or identifying the evidence, is frequently referred to as laying a foundation. Under the Federal Rules of Evidence, a foundation is considered sufficient if a reasonable juror would find it more probably true than not true that the evidence is what the submitting party claims it to be. Evidence is not relevant to a case unless its authenticity can be demonstrated. With digital photos, this poses a challenge, due to the ease of manipulation of digital photos. Software such as Photoshop by Adobe Inc, Picasa by Google Inc., and iPhoto by Apple Inc. enable a layperson to doctor an image in such a way that a juror would not be able to discern which version of the image is the original and which is the edited copy.

There are many instances where authentic, identifiable audio-visual information can contribute to understanding the truth of a case and thus help a judge or jury make the correct judgment. In many cases, a dispute may not even be brought to court, but settled through other acceptable processes. In such cases, the evidence is still an important part of the decision making.

Unfortunately there are many attempts to falsify damage information through the doctoring of photos of the damage. This is particularly troublesome for insurance companies that pay for repair of vehicles damaged in traffic accidents.

In many cases, cars are brought to a repair shop after an accident to be fixed at the expense of an insurance company that insured the car owner. Some policyholders take a photograph or several photographs of the damage either at the repair shop prior to work, or even at the scene of the accident. After the repair, additional photographs are also taken. The “before” and “after” photos are sent to the insurance company in order to receive payment for the repair work.

By providing the insurance company with photos and accident details, a policyholder may receive expedited treatment or a higher payment than if no information was presented. This is because the insurance company has a better understanding of the damages to the vehicle and the cost associated with the repair. However, some policyholders may abuse this avenue and falsify the pictures in order to present a more damaged vehicle than in reality.

If the “before” images are altered in such a way that more damages are claimed than were actually sustained in the accident, the insurance company stands to pay more than actually required for the repair. Sometimes the photos are of a totally different car of the same make. Sometimes the damages are from a previous, unrelated accident. These are examples of insurance fraud that may be undertaken by a policyholder, a repair shop, or the two together.

Unfortunately, there is a real difficulty in ascertaining what really happened at an accident scene. Insurance companies encourage policyholders to take photos at the accident scene in order to decrease the chance of fraudulent claims by third parties involved in an accident with the policyholder. See for example instructions on esurance.com (http://www.esurance.com/Welcome/Home/insurance/fraud.aspx).

If the third party's insurance company will try to obtain exaggerated fees from the policyholder's insurance company for damages purportedly sustained during the accident, photos from the scene supplied by the policyholder may help determine that the third party has filed a fraudulent claim.

However, with the ascent of digital photography, there is a real difficulty in ascertaining the authenticity of digital photos from an accident scene.

U.S. Pat. No. 6,397,334 to Chainer et al, describes a digital camera that captures photos of a damaged car, for example, while simultaneously capturing RFID signals from passive RFID elements previously installed in the vehicle. The RFID data is used as an authenticator, for example as a watermark on the captured photos.

This solution has several limitations including: the need to pre-install RFID circuitry in the vehicle and the additional cost of such RFID circuitry both in the car and in the camera. Such a camera is costly and may not be something handily available in a car accident.

There are numerous “black box” technologies that provide auto crash investigators, insurance companies and legal counsel with significant information regarding a car accident, similar to the black boxes used in the aviation industry. These technologies may include the ability to record various car data such as speed, acceleration, and GPS location as well as capture photos and video. An example is Roadscan Drive Recorder (http://www.roadscan.co.uk/index.php), selling for $300 in 2008. Estimates are that 20% of vehicles have some sort of black box installed.

In 2008, The Progressive Corporation (an auto insurance company, www.progressive.com) launched MyRate to give drivers a customized insurance rate based on how, how much, and when their car is driven. Driving data is transmitted to the company using an on-board telematic device. The device connects to a car's On Board Diagnostic (OBD-II) port (present in all automobiles manufactured after 1996). Cars that are driven less often, in less risky ways and at less risky times of day can receive large discounts on premium payments.

The drawback of these black box solutions is that they don't enable photographing damages from outside the vehicle or of the vehicle itself. Another drawback of such systems is their prohibitive cost of several hundreds of dollars.

### Car Rental

Other places where a dispute over damage may arise are car rental establishments. Today, upon receiving a car in a car rental lot, a customer may mark on the rental contract damaged areas in the car exterior, however this system is imprecise and open to many disputes if the car body is returned damaged to the rental company.

In general, any equipment that is leased or rented, including machinery and real estate, may be damaged through its use and subsequently lead to a dispute between the owner and the customer as to who created what damage.

There is a real business and legal need to record existing states of objects, and changes to these objects after some time. A solution that can detect tampering of recorded evidence may help reduce fraud. A solution that makes it easy to collect timely and precise recorded evidence and transmit it to a service provider may accelerate business processes. These solutions may ultimately improve the relationship of providers with honest customers by reducing suspicions on both sides. Unfortunately existing art does not provide a low cost solution that may be implemented by stakeholders.

### SUMMARY OF THE INVENTION

The above-mentioned shortcomings, disadvantages and problems are addressed by the present invention, which will be understood by reading and studying the following specification.

In an embodiment of this invention, an insurance company employs an Evidence Management System including web-based software and/or personal computer based software, and a plurality of low cost Evidence Recording Devices (hereafter: ERD).

The insurance company issues an ERD to a policyholder upon sign up or renewal of an insurance policy, for example automobile insurance.

The ERD is rugged enough to be carried on a keychain, in a pocket, or in a purse. In some embodiments, the logo and contact information of the insurer are prominently displayed on the ERD encasing.

A car owner (hereafter: customer, policyholder, or end-user, interchangeably) buys an insurance policy from an insurer and, as part of the insurance policy package, receives a branded ERD. The customer finds a place for the device in the car, for example in the glove compartment.

In case of a car accident or damage (hereafter: insurance event), the ERD is readily available for use. The device is used to record the scene, for example to capture images with a still camera feature of the ERD, the damage to the vehicle, third party vehicle and damages (if any), license plates, people involved in the accident, witnesses, identifying documents such as drivers' licenses, insurance papers and whatever information might be useful and/or needed and/or required by the insurer.

As the data is being captured, it is amended with information such as time, date, and the unique serial number of the ERD. The data is digitally signed for authenticity and stored as an evidence media file in the permanent, non-erasable memory storage of the device. Once captured, the evidence cannot be modified by the end-user; this is achieved by using access controlled non-volatile memory to store the data.

After the insurance event, the customer may place the device in an envelope and mail it to the insurer. Optionally, the customer may choose beforehand to attach the device to a personal computer to view and/or copy the data to their computer.

Optionally, a customer may also use a networked service to transmit the data stored on the device to the insurer's computerized systems. The serial number of the device, which is added to each evidence media file during the recording phase, may be used to link between the ERD data and the insurance policy. The insurer's evidence management system verifies the authenticity and integrity of the evidence media file received. Optionally, the data is certified. Optionally, a third party executes the certification process described on behalf of the insurer.

The present invention describes an Evidence Recording Device and methods and systems to use such. In addition to the aspects and advantages of the present invention described in this summary, further aspects and advantages of the invention will become apparent by reference to the drawings and by reading the detailed description that follows.

### BRIEF DESCRIPTION OF THE DRAWINGS

FIGS. 1A and 1B are renderings of embodiments of an Evidence Recording Device.

FIG. 2 depicts a schematic block diagram of an embodiment of an Evidence Recording Device.

FIG. 3 depicts a schematic block diagram of an embodiment of an Evidence Recording Device controller.

FIG. 4 depicts a schematic block diagram of an embodiment of data organization on the non-volatile memory of an Evidence Recording Device.

FIG. 5 is a flow chart of an exemplary method of issuing an Evidence Recording Device to an insurance policyholder.

FIG. 6 is a flow chart of an exemplary method of utilizing an Evidence Recording Device at an accident scene.

FIG. 7 is a flow chart of an exemplary method of capturing evidence by an Evidence Recording Device.

FIG. 8 is a flow chart of an exemplary method for synchronizing time.

FIG. 9 is a flow chart of an exemplary method of transferring data from an Evidence Recording Device to a remote computer.

FIG. 10 is a flow chart of an exemplary method of certifying evidence media files by a remote computer.

FIG. 11 depicts an embodiment of a system for collecting and certifying digital evidence.

FIG. 12 is a flow chart of an exemplary method of utilizing an Evidence Recording Device in a car rental scenario.

### DETAILED DESCRIPTION OF THE INVENTION

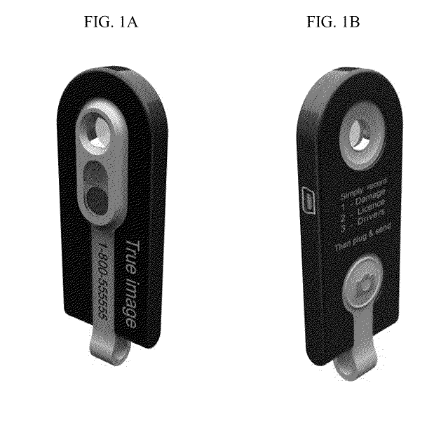

FIGS. 1A and 1B are renderings of an embodiment of an Evidence Recording Device.

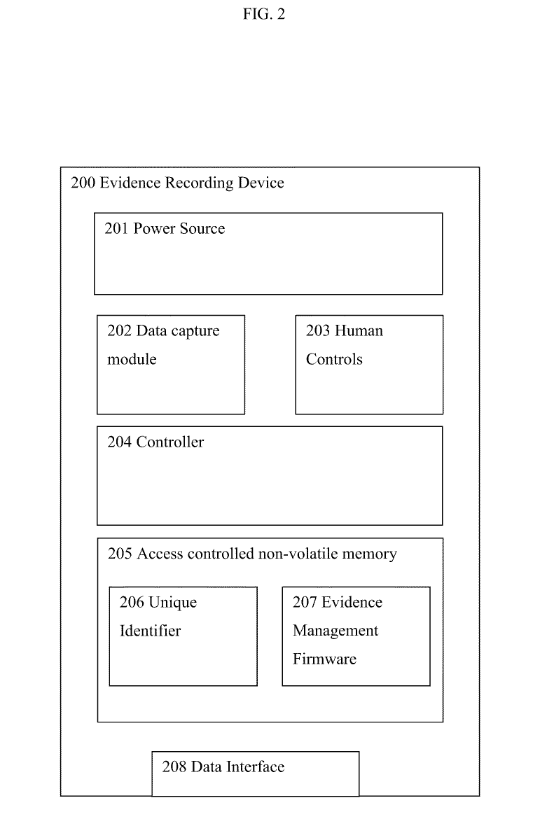

FIG. 2 depicts a schematic block diagram of an embodiment of an Evidence Recording Device 200 (hereafter ERD 200). A power source 201 is used to power the various components of the device, for example image and audio capture. In some embodiments, power source 201 is a built in battery. In some embodiments, powers source 201 is a removable battery such as AA, AAA, and the like, this invention is not so limited. In some embodiments, power source 201 is rechargeable. In some embodiments, the ERD 200 components draw little or no power from power source 201 while ERD 200 is not in use.

Data capture module 202 converts audio-visual information into a digital representation (hereafter: digital evidence). In some embodiments, data capture module 202 creates a digital still image. In some embodiments, data capture module 202 creates a digital video clip. In some embodiments, data capture module 202 creates an audio recording. In some embodiments, data capture module 202 creates a combination of still images, video, and audio, this invention is not so limited.

In some embodiments, the digital evidence captured by ERD 200 may be stored in a raw format. In some embodiments, it may be an industry standard format such as BMP, TIFF, JPG, PNG, MPEG, AVI, WAV, MP3, and the like, this invention is not so limited. In some embodiments, the digital evidence may be stored in a proprietary format.

In some embodiments, data capture module 202 is composed of optics and electronic elements adapted to capture an entire accident scene, close ups of a damaged vehicle, face shots of parties involved, and various documents such as drivers licenses and insurance documents.

Human controls 203 provides a means for a person to trigger functions. In some embodiments, human control means 203 includes a shutter release button, that, when pressed, commands ERD 200 to capture a digital still image. In some embodiments, the captured image is further processed before being stored.

In some embodiments, the only control present is a shutter button. In some instances, there is benefit in having the least number of human controls on ERD 200, as this simplifies the operation of the device. Simpler operation is important due to the variety of end-users and skill levels, and also due to the expected high level of stress when the device is in use (e.g. after an accident). In some embodiments, for example, the audio recording feature may be triggered simultaneously with the triggering of an image capture by clicking a shutter button. Alternatively it may be triggered by ambient noise above a threshold level within a certain period after the shutter button was pressed. This type of combination removes the need of a dedicated button to control audio capture. In some embodiments, though, more than one human control is present, this invention so not so limited.

Controller 204 controls the operation of ERD 200 and may be directly or indirectly connected to other components. Controller 204 may include internal Random Access Memory (hereafter: RAM) for the temporary execution of code and/or storage of data. In some embodiments, the RAM is external to the controller. In some embodiments, controller 204 includes an interface module to communicate with a personal computer (hereafter: host, host computer, personal computer, or PC, interchangeably). In some embodiments, controller 204 includes provisions for security processing, for example it may have an internal non-volatile memory to store secret codes and/or means for encrypting data, such as an encryption engine and/or means for authentication to a host such as PKI functions, tamper resistance methods and the like, this invention is not so limited. In some embodiments, controller 204 takes an active role in the process of capturing an image and/or the conversion of audio-visual information into digital representation. In some embodiments, controller 204 is combined with data capture module 202 to form one component.

Access controlled non-volatile memory 205 is ERD 200's storage space for audio-visual information elements and other data. In some embodiments, access controlled non-volatile memory 205 is a physically non-erasable memory such as PROM or other types of one time programming (OTP) components. In some embodiments, access controlled non-volatile memory 205 is a rewriteable non-volatile memory, such as flash memory.

In some embodiments, access controlled non-volatile memory 205 is a rewriteable non-volatile memory where the non-erasable and/or non-modifiable properties are accomplished by the operation of the controller (e.g. not allowing deletion or modification of data). In some embodiments, some parts of access controlled non-volatile memory 205 have no access restrictions. In some embodiments, access controlled non-volatile memory 205 is comprised of a combination of the above non-volatile memory types, this invention is not so limited.

In some embodiments, access controlled non-volatile memory 205 is a multitude of components or sub-components, for example some of access controlled non-volatile memory 205 may be integrated into controller 204.

In some embodiments, access controlled non-volatile memory 205 stores software code adapted to be executed by controller 204. In some embodiments, the software code is stored elsewhere.

Unique identifier 206 is used to uniquely identify a single ERD 200 out of a plurality of devices. In some embodiments, unique identifier 206 is a serial number. In some embodiments, unique identifier 206 is large random number. In some embodiments, unique identifier 206 is a binary code to be used with one or more cryptographic algorithm and/or method. In some embodiments, unique identifier 206 is a meaningful combination of data, for example a time and place of specific ERD manufacturing, a secret code, a certificate, or a combination of these. In some embodiments, unique identifier 206 is adopted to be coupled to a system, for example, a content management system. In some embodiments, there are a plurality of unique identifier 206's for different uses or systems.

In some embodiments, each ERD 200 is assigned one or more unique serial number or identification code (hereafter used interchangeably), represented by unique identifier 206. When an audio-visual information element has been captured by ERD 200, it is stored in access controlled non-volatile memory 205 as an evidence media file. In some embodiments, additional information is added to the evidence media file, for example, unique identifier 206, date and time, GPS location, and the like. In some embodiments, the additional information may be added to the source media file. In some embodiments, information is visually overlaid over an image or video frame. In some embodiments, information is added to a sound recording as an artificial human voice. In some embodiments, the information is digitally embedded in a non-visual/non-sound form.

In some embodiments, in order to provide for methods to verify the authenticity and integrity of digital evidence, cryptographic algorithms are used, for example a message digest calculated by using MD5 or SHA-1 algorithms, and/or message authentication codes, for example HMAC and/or a digital signature or digital watermark or the like methods. The cryptographic methods used may be related to or use one or more unique identifier 206. In some embodiments, part or all of the data calculated by these methods is added to the evidence media file. In some embodiments, the data is stored separately. At a later time, this data may be extracted from the file, for example by the insurer's software, in order to verify and/or certify the authenticity and integrity of a media file. In some embodiments, the signature or watermark is stored separately from the data captured.

In some embodiments, unique identifier 206 is adopted to be associated with an entry in a database that is used with reference to a specific customer, for example in a corporate customer management system (CMS). In some embodiments, unique identifier 206 is adopted to be associated with an entry in a database that refers to specific equipment, for example equipment for lease, managed by lease management software (for example http://www.litehaus360lease.com/). In some embodiments, unique identifier 206 is adopted to be associated with a specific insurance policy. In some embodiments, more than one ERD 200, and therefore more than one unique identifier 206 are adopted to be associated with a specific insurance policy. In some embodiments, the human readable form of unique identifier 206 is a serial number.

In some embodiments, the ERD 200 serial number appears prominently on the device encasing, enabling the policyholder to easily provide the serial number to a claims adjuster or to type it in to a computer.

Evidence Management Firmware 207 is computer software code adapted to execute on controller 204. In some embodiments, evidence management firmware 207 adds a presentation of unique identifier 206 and/or time and/or date etc. to an audio or visual information element captured by data capture module 202. In some embodiments, evidence management firmware 207 adds an electronic signature, a hash code, a message authentication code, or the like to captured data in order to enable verifying authenticity and integrity of the data at a later time.

In some embodiments, evidence management firmware 207 manages the storage of captured data on access controlled non-volatile memory 205. In some embodiments, evidence management firmware 207 manages usage rights of data stored on access controlled non-volatile memory 205, for example disabling an end-user from modifying an evidence media file once it has been recorded. In some embodiments, evidence management firmware 207 restricts the access to access controlled non-volatile memory 205 in order to mimic the behavior of a read only storage device coupled to host computer, in a way that an end-user using the computer cannot modify or delete evidence media files stored in access controlled non-volatile memory 205. In some embodiments, evidence management firmware 207 maintains the ability to modify data stored on access controlled non-volatile memory 205 internally by ERD 200, for example to add new evidence media files or add metadata to stored evidence media files.

In some embodiments, evidence management firmware 207 maintains a list of captured data. In some embodiments, evidence management firmware 207 synchronizes time with a remote time synchronization service. In some embodiments, evidence management firmware 207 prepares data for transfer to a personal computer. In some embodiments, evidence management firmware 207 prepares data for transfer to a remote server. In some embodiments, evidence management firmware 207 prepares data for presentation to the end-user. In some embodiments, evidence management firmware 207 handles the creation of a secure communications channel (HTTPS, SSL, etc) over the Internet to transfer data, for example to an insurer's computer systems for claim processing.

Data interface 208 enables communicative coupling of ERD 200 to a computer. In some embodiments, data interface 208 is a USB interface and ERD 200 connects to a personal computer in order to transfer images and data from ERD 200 to the PC. In some embodiments, data interface 208 is a wireless interface such as Wi-Fi, Wi-Max, GPRS, 3G cellular, and the like, enabling ERD 200 to connect to a remote computer. In some embodiments, data interface 208 is Firewire, serial RS232 or the like, this invention is not so limited.

In some embodiments, ERD 200 further comprises lighting means used for illuminating a scene in low light conditions, such as night, in order to better record visual information. In some embodiments, the light source is an LED (Light Emitting Diode) or the like, this invention is not so limited. In some embodiments, ERD 200 further comprises an ambient light sensor used to determine if the lighting means needs to be used when recording visual information.

In some embodiments, ERD 200 further comprises a display screen in order to present to an end-user evidence media files that have been captured. Other information may be displayed such as ERD 200 status and configuration information or options for user selection. In some embodiments, ERD 200 does not comprise a display screen.

In some embodiments, ERD 200 further comprises a sound and/or voice and/or light producing element that may produce human discernable feedback regarding ERD 200, for example a clicking sound when an audio-visual information element is being captured, a red LED flashing when access controlled non-volatile memory 205 is full or the battery is low, and the like. In some embodiments, feedback is provided at regular intervals while an audio or video recording is taking place.

In some embodiments, ERD 200 further comprises a time keeping mechanism to track time and date. In some embodiments, time and date information is added to each evidence media file, in order to improve authenticity and identification. In some embodiments, ERD 200 comprises time synchronization means, with the ability to receive time and date from an external source, for example WWVB (e.g. http://tf.nist.gov/stations/wwvb.htm).

In some embodiments, ERD 200 further comprises a location determination means, such as a GPS receiver, or a cell phone tower triangulation means. In some embodiments, ERD 200 may interface with other GPS or cell phone devices in order to obtain location information.

In some embodiments, ERD 200 further comprises a sound sensing mechanism that when tripped, initiates some activity such as sound capture, image capture, video capture, and the like.

In some embodiments, ERD 200 further comprises an accelerometer, to identify acceleration. In some embodiments, ERD 200 starts recording when an abnormal acceleration or deceleration (for example an accident) is identified.

In some embodiments, some or all of the components of ERD 200 are encased in a tamper-evident shell, meaning that the internal components cannot be exposed and/or accessed without breaking or deforming the shell or part of it in a way that is not evident.

In some embodiments, ERD 200 further comprises a safety lock to prevent accidental operation of the device. In some embodiments, the safety lock may be a cover over at least part of human controls 203, for example the shutter button. In some embodiments, the safety lock may have an additional function once unlocked, for example if it is a hinged element, when closed it covers the shutter button, and when opened it expands beyond the dimensions of ERD 200 to expose a viewfinder. In some embodiments, the safety lock is for a single use, once detached it cannot be returned to its previous protective location.

In some embodiments, ERD 200 further comprises a physical connector for easy storage and transport by an end-user. In some embodiments, the physical connector attaches to a key chain, enabling an end-user to carry ERD 200 together with the car keys. In some embodiments, the physical connector enables attaching ERD 200 to a vehicle dashboard or sun visor. In some embodiments, an additional physical element may be used as a fixture that ERD 200 attaches to. In some embodiments, the physical connector is adapted to attach to an article of clothing, for example a shirt pocket, a belt, and the like. In some embodiments, ERD 200 is designed to be stored in a convenient place such as the glove compartment of a car. In some embodiments, ERD 200's encasing includes a ring and is a keychain. In some embodiments, ERD 200 is encased in a car key housing.

It will be appreciated by those skilled in the art that various combinations of the components described above are possible, a plurality of each of ERD 200's components may exist, two or more components may be combined to form one component of larger scope, or a component may be split to form two or more components, this invention is not so limited.

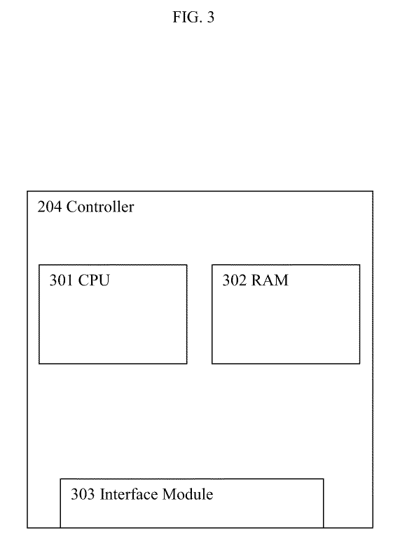

FIG. 3 depicts a schematic block diagram of an embodiment of an Evidence Recording Device controller. Controller 204 is comprised of at least a CPU 301 for executing code. In the depicted embodiment, controller 204 is further comprised of Random Access Memory (RAM) 302 to store or cache code and/or data for execution, and interface module 303 to communicate with other computing devices through data interface 208 of ERD 200, for example circuitry that complies with one or more of the following protocols: USB, FireWire, SD, SDIO, Wi-Fi, GPRS, 3G, HSPDA, WiMax, and the like wired or wireless interfaces.

In some embodiments, controller 204 is additionally comprised of security circuitry, such as an encryption engine, for example an AES engine and or SHA-1 engine and/or secret key (such as public/private key pair) generation circuitry and/or co-processing functions, and the like. In some embodiments, controller 204 is additionally comprised of internal secure non-volatile memory, which may be utilized for storing secret codes. In some embodiments, controller 204 is additionally comprised of signal processing circuitry utilized for still image, video, or audio processing, for example to overlay textual data over a captured image. In some embodiments, controller 204 is adapted to perform hashing functions, for example create a hash key based on ERD 200's unique identifier 206 and calculate a hash message authentication code (hereafter: HMAC) for each evidence media file stored on ERD 200.

Those skilled in the art may appreciate that a plurality of each of controller 204's components may exist as well as that two or more components may be combined to form one component of larger scope, or a component may be split to form two or more components, the invention is not so limited.

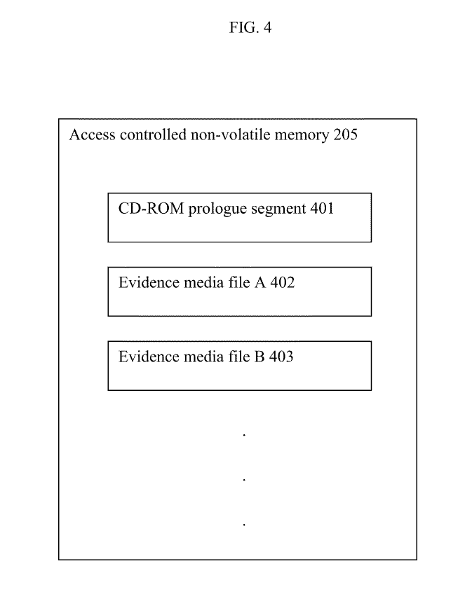

FIG. 4 depicts a schematic block diagram of an embodiment of data organization on the non-volatile memory of ERD 200.

The following common definitions are used in the subsequent paragraphs: CD-ROM media (also just CD-ROM) is a round shaped disc on which data is stored physically in an optical format, CD-ROM drive is a device capable of reading data from a CD-ROM media. CD-ROM driver is software, usually incorporated in an operating system (such as Microsoft Windows) that handles the communications with a CD-ROM drive.

In some embodiments, ERD 200 is designed to emulate, when coupled with a host personal computer, the behavior of a CD-ROM drive housing a read-only CD-ROM media containing evidence media files. In some embodiments, the CD-ROM media is formatted according to a standard format (also called CD-ROM file system format), for example ISO 9660, HFS, ISO-HFS, UDF or the like formats. This inherently restricts the actions that the end-user of the personal computer expects to execute on the evidence media files.

Since CD-ROM drives are widely used devices, the operating system executing on the personal computer presents a user interface in which the read-only properties of ERD 200 are evident. Additionally, by emulating CD-ROM behavior, an auto-launch of evidence management software is enabled on the personal computer, an advantage for end-users who do not need to locate and activate this software manually.

Attempts of an end-user to modify, delete, or add files to ERD 200 emulating a CD-ROM are blocked, either by the host computer operating system or by ERD 200. This presentation of data stored on ERD 200 to a host computer is in contrast to the read/write access internally in ERD 200 while capturing data.

In some embodiments, access controlled non-volatile memory 205 holds several data structures in order to emulate a read-only CD-ROM when ERD 200 is coupled with a computer, and yet allow read and write access internally to ERD 200. CD-ROM prologue segment 401 is of a predefined size and contains data that, at least in part, will remain unchanged when ERD 200 is coupled to a computer. In some embodiments, CD-ROM prologue segment 401 contains data formatted according to the first several sectors of a standard CD-ROM structure. In some embodiments, CD-ROM prologue segment 401 includes at least volume and directory structure data, for example at least a volume descriptor and path table as defined in ISO 9660. In some embodiments, CD-ROM prologue segment 401 includes one or more files or directories, for example files required to enable the auto launch feature, software, ERD 200 operation manual, forms, a root directory, a directory meant for evidence media files, and the like files. In some embodiments, CD-ROM prologue segment 401 contains data that is not necessarily the same as the first several sectors of the CD-ROM standard, for example it does not have to include the first few sectors known as system data which are used to enable a computer to boot from a CD-ROM.

Evidence media file A 402 is a file representing an audio-visual information element captured by ERD 200. Evidence media file B 403 is file representing an audio-visual information element captured by ERD 200 after evidence media file A 402 was created.

In some embodiments, when the ERD 200 is manufactured, a CD-ROM prologue segment 401 is stored in access controlled non-volatile memory 205. When the first evidence media file is created, it is stored as evidence media file A 402 in access controlled non-volatile memory 205. In some embodiments, each evidence media file stored in access controlled non-volatile memory 205 is formatted according to the CD-ROM file system standard. In some embodiments, deviations from the standard format are imposed due to the nature of access controlled non-volatile memory 205, which for example might be a flash memory or an OTP memory. In some embodiments, evidence media files are stored with a proprietary format or with proprietary modifications to a standard format. For example, a proprietary prefix to a file may be added before the file data and a proprietary suffix added following the file data. In some embodiments, these modifications allow for locating of files in access controlled non-volatile memory 205 in the absence of an updated file location table or directory.

In some embodiments, ERD 200 prepares the data stored on access controlled non-volatile memory 205 for output to a personal computer, for example after being coupled to a computer. In some embodiments, the preparation includes calculating file location tables or file directories. In some embodiments, the preparation includes calculating the appropriate data for CD-ROM prologue segment 401. In some embodiments, the preparation includes generating a translation table between locations of the various parts of the CD-ROM structure, for example those stored in access controlled non-volatile memory 205, and locations as expected for a true CD-ROM media. In some embodiments, ERD 200 completes filling in the directory structure as defined in CD-ROM prologue segment 401. In some embodiments, following the preparation, ERD 200 may produce data that can be used to emulate a CD-ROM drive housing CD-ROM media, which includes one or more evidence media files and is compatible to one or more of the CD-ROM standards.

In some embodiments, when ERD 200 is coupled to a host computer, evidence management firmware 207 executed by controller 204 acts as an intermediary between non-volatile storage 205 and the host PC CD-ROM driver. Instead of reading a true CD-ROM structure, the CD-ROM driver reads data that is patched together in real time by evidence management firmware 207.

In some embodiments, in order to expedite the process of preparation of data to be transferred to a coupled host computer, parts of CD-ROM prologue segment 401 may be updated to reflect the addition of an evidence media file to the data structure following the file creation. As each new evidence media file is added to the data structure, this process continues.

In some embodiments, ERD 200 identifies itself to the personal computer as a non-writable media device other than a CD ROM drive, for example a DVD drive, a read only hard drive, or a network adapter, this invention is not so limited.

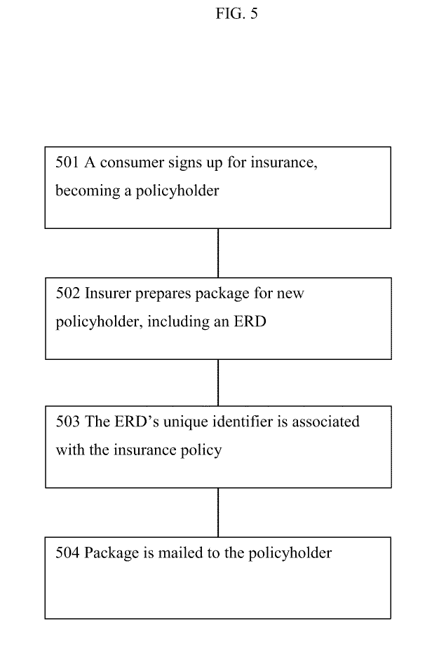

FIG. 5 is a flow chart of an exemplary method of issuing an Evidence Recording Device to an insurance policy holder.

In step 501, a consumer signs up for an insurance policy with insurer and becomes a policyholder. In step 502, the insurer prepares a package for the policyholder including the insurance contract, additional policy documents, and an ERD 200. In step 503, the ERD 200 serial number, representing unique identifier 206, is associated with the policyholder's insurance policy on the insurer's data management systems. In step 504, the package is mailed to the policyholder.

In some embodiments, more than one ERD 200 may be sent to the policyholder. The policyholder may be required to utilize one of the ERD 200 to photograph the insured vehicle within a set time and send it back to the insurer. This provides an agreed upon “zero state” of damages to the policyholder's vehicle. In some embodiments, this action may be required by the policyholder in order to receive a reduction in premium payments.

In some embodiments, more than one ERD 200 may be sent to the policyholder because more than one person regularly uses the vehicle. Each driver may maintain their own ERD 200 on their personal keychain or purse.

In some embodiments, in such cases of multiple ERD 200s, each of the ERD 200s' serial numbers is separately associated with the insurance policy.

In some embodiments, an ERD 200 is mailed to a policyholder separately. This may be, for example, due to a malfunction in an originally sent ERD 200. This may also happen, for example, if the policyholder lost his or her ERD 200. This may also happen, for example, if a previous accident has been recorded using an ERD 200 and a new one must be issued to the policyholder.

In some embodiments, an insurance policy and documents are sent separately to the policyholder because the ERD 200 has a battery life of several years, whereas insurance policies are renewed every 6 or 12 months.

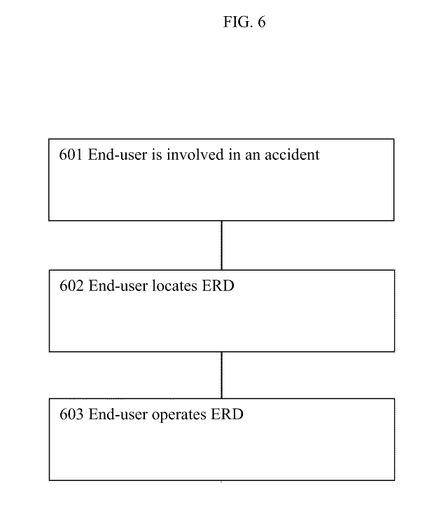

FIG. 6 is a flow chart of an exemplary method of utilizing an Evidence Recording Device at an accident scene.

In step 601, an end-user is involved in an automobile accident. In step 602, the end-user locates an ERD 200 and exits the car. In step 603, the end-user operates ERD 200, recording for example the accident scene, damages to all vehicles involved, people involved, and identification and insurance documents of parties involved in the accident.

In some embodiments, in order to begin capturing photos, a safety lever must be removed. In some embodiments, a safety lever must be moved, this invention is not so limited.

In some embodiments, an end-user captures more than one photo of each audio-visual information element. Later processing can then create an improved evidence media file and compensate for blurry or incorrectly captured photos that are the result of the expected anxiety of the end-user following an accident reflecting on the way ERD 200 is operated. This is also relevant in embodiments where ERD 200 does not have a display that could have provided end-user with feedback by viewing the captured photo.

In some embodiments, ERD 200 emits voice instructions to provide an end-user with operating guidance. In some embodiments, the instructions include a step-by-step walkthrough of required data for capturing. In some embodiments, ERD 200 may emit a voice request to re-capture an audio-visual information element because the captured data, for example a photo, is of less than required quality.

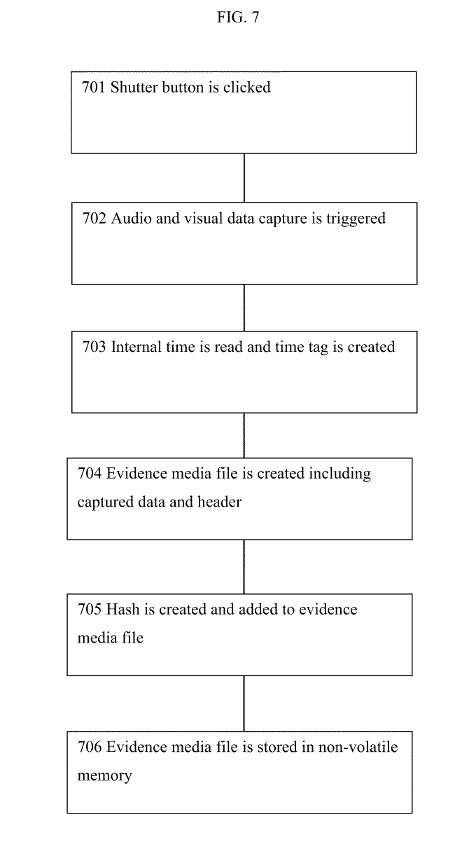

FIG. 7 is a flow chart of an exemplary method of capturing evidence by an Evidence Recording Device. In step 701, evidence capture is initiated by operating the shutter button of ERD 200. In step 702, audio-visual data capture is triggered. In some embodiments, a digital still picture is captured. In some embodiments, an audio recording of a fixed length is initiated, for example 60 seconds. In some embodiments, the audio recording enables the end-user to verbally illustrate the accident scene and damage. In some embodiments, the data captured is a video clip of a fixed length. It can be appreciated by those skilled in the art, that ERD 200 may capture any combination of still images, video and audio, this invention is not so limited. In some embodiments, a visual and/or audio cue is provided to the end-user to signify the start and/or end of evidence data capture.

In step 703, ERD 200 fetches the date and time at the moment of shutter depression and creates a time tag (also called timestamp).

In step 704, an evidence media file is created comprising of the captured evidence data, the time tag, and an ERD 200's specific unique identifier. In some embodiments, the time tag and identifier are stored separately from the captured data.

In step 705, the evidence media file is hashed, using an iterative cryptographic hash function, such as MD5 or SHA-1, to produce a hash code. Additional cryptographic functions may be used. The results of the cryptographic functions serve to establish both the data integrity and the authenticity of the evidence data for verification at a later time.

In step 706, the evidence media file and the hash code are stored in access controlled non-volatile memory 205 of ERD 200. In some embodiments, the results of the cryptographic functions are added to the evidence media file. In some embodiments, they are stored separately.

In some embodiments, once stored in access controlled non-volatile memory 205, the evidence media file may not be deleted, amended, or edited, due to the physical write-once the nature of the non-volatile memory or through access control managed by evidence management firmware 207.

In some embodiments, ERD 200 stops allowing data capture after a certain amount of time has passed from first data capture, for example one day or one week after first data capture. This may be done to limit data capture to a specific insurance event.

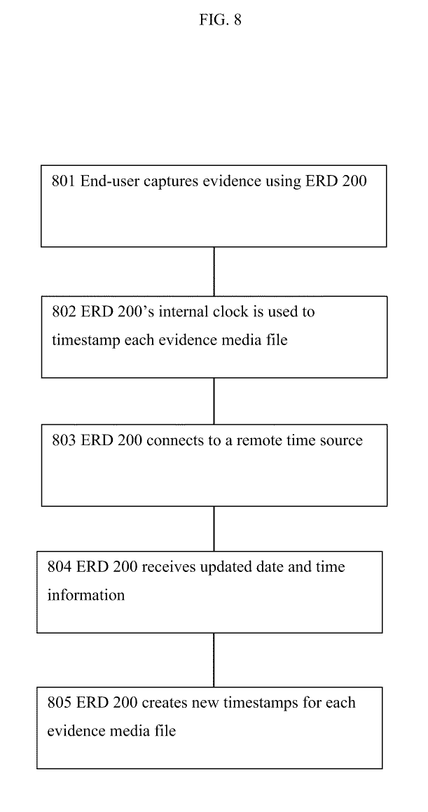

FIG. 8 is a flow chart of an exemplary method for synchronizing time. In some embodiments, ERD 200 includes a time keeping mechanism such as an internal clock. Unfortunately, many time keeping mechanisms are inaccurate, and over a long period the time kept is substantially different than the actual time. In such cases, synchronization with an external, trusted time source may be used. However, synchronization is not always possible while capturing evidence at the scene of an accident.

In some embodiments of this invention, ERD 200 synchronizes time after the audio-visual information elements have been captured. The following is a description of such an embodiment.

In step 801, end-user captures audio-visual information element representing evidence. In step 802, ERD 200 associates internal time and date with each element, creating a timestamp. In step 803, ERD 200 is connected to a remote server. The connection may be through ERD 200 coupled to an online computer or directly, for example wirelessly, between ERD 200 and a remote server, this invention is not so limited. In step 804, ERD 200 receives an accurate date and time, and updates its internal time keeping mechanism. In step 805, each of the audio-visual evidence files is time-stamped once again.

In some embodiments, the new timestamp replaces the older one. In some embodiments, where there is no substantial difference between the timestamps, the new timestamp is not used. In some embodiments, evidence media files are not time-stamped again (for example in order not to change an evidence media file), but a time-fixing value is calculated and stored in access controlled non-volatile memory 205. The time-fixing value may be later used to adjust the time of each evidence media file. In some embodiments, the time-fixing value applies to one or more evidence media files. In some embodiments, more than one time-fixing value is stored, corresponding to more than one time synchronization events.

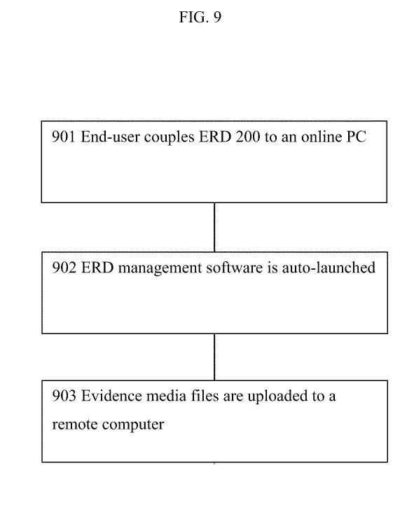

FIG. 9 is a flow chart of an exemplary method of transferring data from ERD 200 to a remote computer.

In step 901, ERD 200 is coupled with a local computing device such as a personal computer that is connected to a network. In step 902, an ERD 200 management application is auto-launched. In step 903, one or more evidence media files previously stored in ERD 200 are uploaded to a remote computer.

In some embodiments, various actions may be performed before the evidence media files are uploaded, for example adding an accurate timestamp to each evidence media file, compressing the evidence media files, adding textual descriptions of the evidence media files, and the like, this invention is not so limited. In some embodiments, the end-user performs actions using the application. In some embodiments, the actions are performed automatically by the application, running on the host PC or by a remote server.

In some embodiments, ERD 200 is coupled to a personal computer through a wired interface, such as USB or FireWire, or through a wireless interface such as WiFi or Bluetooth, this invention is not so limited.

In some embodiments, the local PC may not be connected to the Internet. In such cases, the application may create a local, optionally encrypted copy of the data meant for upload and store it on the PC's hard drive for upload at a later time. In some embodiments, the data may be packaged as an email message and stored in an email client outbox.

Normally, in order for a PC to be able to communicate with a peripheral device, some software (referred to a device driver) has to be installed on the PC prior to the coupling. In order to avoid driver installation on a policyholder's PC merely for being able to access the data on ERD 200, it may identify itself to the PC as one of several standard computer peripherals. By taking advantage of software that already exists on most PCs that support standard hardware, the PC may be able to access data on ERD 200 without the need to install a driver.

In some embodiments, the evidence media files data stored in ERD 200 is non-rewritable. ERD 200 identifies itself to the PC as a non-writable media such as a CD ROM drive, A DVD drive, a read only hard drive, or a network adapter. In some embodiments, ERD 200 may identify itself to a host computer as a CD ROM drive with CD ROM media already inserted. When attached to a computer, the standard process of attaching an external CD ROM drive is employed by the computer's operating system. For example, Microsoft Windows uses a program named Explorer to display the CD ROM media content to the end user. Additionally, Windows also has an auto-run feature that initiates a program stored on the CD ROM media, which can be used to provide a friendlier display and initiate an application stored on the CD ROM media. A data upload application stored in the access controlled non-volatile memory 205 of ERD 200 is then launched.

In order for a personal computer to be able to retrieve data from ERD 200, the data should be arranged in a format that complies with the emulated device and/or media. For example, a standard method to arrange data in a hard drive (or read only hard drive) is in a structure referred to as file system, for example FAT, NTFS, and the like. If the device presents itself as a read only hard drive, the data must appear to the personal computer as being organized in a file system structure. CD-ROM and DVD media have data organized in one of a variety of file systems etc. In some embodiments, ERD 200 stores the captured data on non-volatile storage 205 in a format compatible to the media being emulated, so that when accessed by the computer, the data is transferred from access controlled non-volatile memory 205 to the PC as it had been previously stored.

In some embodiments, ERD 200 stores one type of structure on non-volatile storage 205 and re-structures the data while transferring it to the personal computer, according to the media being emulated. For example, ERD 200 maintains a read/write CD ROM (or DVD) format during image capture, allowing new evidence media files to be added to the structure. Once attached to a host computer, ERD 200 creates a non-rewritable CD-ROM version of the data for transfer.

In some embodiments, the host PC retrieves data from ERD 200 using a standard program, installed with the computer's operating system. In some embodiments, the host PC retrieves data from ERD 200 using dedicated software, installed for a specific purpose.

The data retrieved from ERD 200 includes captured data (evidence media files) and metadata created by ERD 200 such as a timestamp, device serial number, location and the likes. In some embodiments, the metadata is embedded in the individual evidence media files.

In some embodiments, additional data is stored on ERD 200. Additional data may include a user manual, instructional video, or presentation that demonstrates how to use the device and/or communicate with an insurer (or other organization). Additional data may also include software that is to be run by the insurer or by other business partners such as a repair shop, agent, attorney, and the like, this invention is not so limited.

In some embodiments, the management application enables various end-user activities while ERD 200 is attached to a personal computer, for example, viewing the data captured and stored on the device's access controlled non-volatile memory 205 (images, video, audio, time, date etc.), copying the data to the PC, organizing the data, and initiating data upload to a remote system. In some embodiments, the application allows the end-user to fill in forms that will be uploaded to the remote server, for example ACORD standard forms.

In some embodiments, the host computer's auto-run feature initiates a software application that enables an end-user to choose between options, such as: view the evidence media files, copy the evidence media files to the host PC, view a manual or video, upload data to the insurer (or other organization or service), and the like. The presentation of an options menu can be performed in various ways, such as invoking a program stored on the device, or initiating a web page stored on the device which results in its presentation through the web browser of the personal computer, a link to an online URL, and the like, this invention is not so limited.

It will be appreciated by those skilled in the art, that providing the maximum amount of information regarding an insurance claim in one data set, simplifies the process for the policyholder, simplifies the process of claims adjustment for the insurance company, and ultimately saves time in processing the claim by the insurance company.

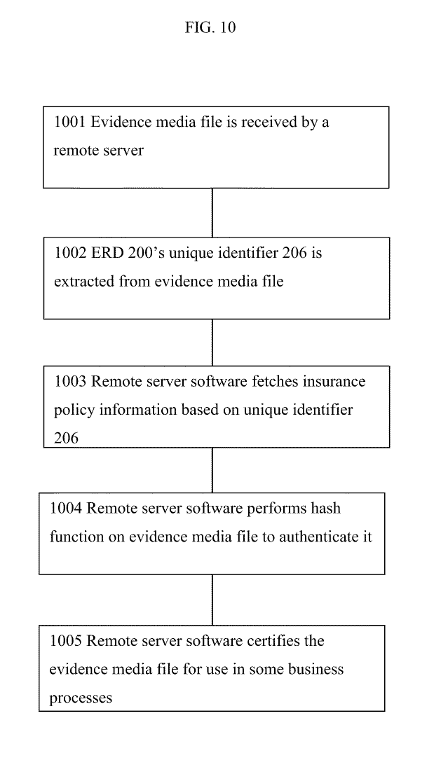

FIG. 10 is a flow chart of an exemplary method of certifying evidence media files by a remote computer. The remote computer may be a server operated by an insurance company, an agent of an insurance company, an insurance broker, an attorney, a body shop, a service provider dedicated to ERD management services, or any other third party with access to some end-user insurance policy data, this invention is not so limited.

In step 1001, the remote computer server software receives an evidence media file, originating from a remote ERD 200, through the Internet. In step 1002, the server software extracts unique identifier 206 of ERD 200 from the evidence media file. In step 1003, the server software, based on ERD 200's unique identifier 206, fetches the insurance policy information, including for example, policyholder's personal information, property information, claims history, and the like. In step 1004, the server software uses cryptographic algorithms (for example using HMAC) to authenticate the evidence media file as truly originating from the ERD device with the stated unique identifier, and verifies the integrity of the file (has not been modified). In step 1005, the server software certifies the evidence media file and forwards it, together with additional information to a claims adjustment system for processing.

In some embodiments, more than one evidence media file is transferred. In some embodiments, additional files are transferred, for examples claims forms completed with insurance event details. In some embodiments, these forms are based on ACORD standards.

In some embodiments, an evidence media file is certified if it was not altered and was created by the ERD 200. In some embodiments, the entire data received from an ERD 200 is certified if each individual evidence media file was certified, and the server receives all the evidence media files that were created by ERD 200.

In some embodiments, the server does not fetch end-user related information, and the certification is provided with relation to the unique identifier 206, meaning that the image is certified to have been captured by an ERD 200 that carries the stated unique identifier 206 and it was not altered. In some embodiments, the relation of ERD 200 to a specific end-user is achieved by other means.

In some embodiments, the certification is provided in digital form, for example an X.509 compliant certification. In some embodiments, the server prepares user-readable indication of the certification for presentation, for example on a webpage.

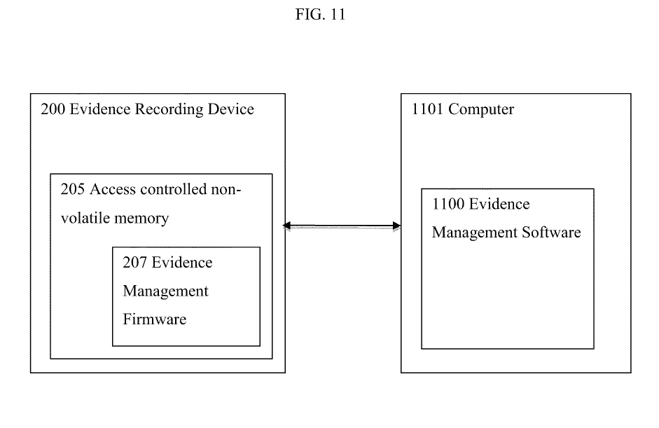

FIG. 11 depicts an embodiment of a system for collecting and certifying digital evidence. ERD 200 records audio-visual information elements and stores them as evidence media files in access controlled non-volatile memory 205. Evidence Management Firmware 207 executes in ERD 200.

Evidence Management Software (EMS) 1100 executes on a computer 1101. EMS 1100 receives and processes evidence media files from ERD 200. In some embodiments, EMS 1100 may execute in a distributed manner, on several computers. In some embodiments, at least part of EMS 1100 executes on a remote server. In some embodiments, at least part of EMS 1100 executes on an insurance company's servers. In some embodiments at least part of EMS 1100 executes on a personal computer.

In some embodiments, EMS 1100 initiates a secure network connection with evidence management firmware 207 of ERD 200, for example using SSL, SSH, https, ftps, and the like protocols. Once such a connection is established, chances of data tampering decrease. In some embodiments, one or more unique identifier 206's are used during the initiation of such connection.

In some embodiments, EMS 1100 verifies (authenticates) that an evidence media file has originated from a specific ERD 200 with specific unique identifier 206. In some embodiments, the authentication is performed using cryptographic algorithms, for example HMAC and the like algorithms. In some embodiments, EMS 1100 authenticates an ERD 200's evidence media files and data one by one as they are uploaded. In some embodiments, the authentication occurs only after all the evidence media files have been uploaded. In some embodiments, EMS 1100 additionally authenticates an entire ERD 200 once all the files created by the device have been uploaded and authenticated. In some embodiments, EMS 1100 verifies that all the files stored on ERD 200 have been uploaded.

In some embodiments, EMS 1100 certifies evidence media files and additional data supplied by ERD 200 by generating a digital certificate for example an X.509 compliant certificate. In some embodiments, a single certificate is used. In some embodiments, each file receives a different certificate.

In some embodiments, once the data from ERD 200 has been certified, it becomes a resource for use in other data systems used by the insurer for example content management systems, claims adjustment systems and the likes.

In some embodiments, after certification, third parties may gain access to part of the evidence media files and data, for example a repair shop may view some photos of auto body damage to ascertain which repairs will be covered by the insurance company.

In some embodiments, once the data has been received and/or certified by EMS 1100, a message is sent to the insurer's customer service center, which then initiates a customer service call to the policyholder.

In some embodiments, the evidence media files transferred to the insurer server are not an exact replica of the audio-visual information elements presented to the end-user. For example, images viewed by the end-user may be visually marked with date and time overlaid on the image, while uploaded images may have that information embedded elsewhere, so that the image data is not altered by an overlay. In some embodiments, end-users may copy and view compressed images while raw or uncompressed images are uploaded to the insurer's servers.

In some embodiments of this invention, the EMS 1100 assists an end-user in preparing the data for transmission to the insurer's server system. For example, in the case of an automobile accident, the software aids the end-user in organizing the evidence media files into categories: accident scene, vehicle damage close ups, drivers license, third party documents, and the like. In some embodiments, the software enables the end-user to complete forms and add information such as personal details, details of other parties involved in the accident, details of witnesses, accident event description, and the like.

In some embodiments, after the end-user has completed various activities related to the data on ERD 200, the application automatically initiates an upload of information to the insurer's servers. In some embodiments, the end-user initiates the upload. In some embodiments, the upload is initiated automatically when ERD 200 is plugged into an online PC. In some embodiments, data is uploaded immediately following its creation in ERD 200, for example through a wireless connection.

Those skilled in the art will appreciate that, by proving the policyholder with tools for an orderly procedure of accident data and information upload, the insurer receives at least part of the data with attributes that match its business process, potentially saving time and expenses.

In some embodiments, using ERD 200 reduces the time and hassle spent by a policyholder at an accident scene. In some embodiments, a faster processing of claims is offered to policyholders who use ERD 200 and EMS 1100 to provide accurate insurance event information to the insurer.

It can be appreciated by those skilled in the art, that the early and orderly collation of accident data and evidence captured at the accident scene can improve the accuracy of claims adjustment and speed up the claims processing. By using the system described by the present invention, the claims adjuster saves time because there are fewer cases where an appraiser is required to physically assess the true damage to the vehicle. Furthermore, it may not be necessary to contact the policyholder for information, because all the information required to process the claim is already available. Furthermore, soft insurance frauds may be reduced because the policyholder is held to the evidence provided in ERD 200.

It can further be appreciated by those skilled in the art, that by using the system described by the present invention to collect and authenticate insurance event information, the business process of insurance claim processing and adjusting may be expedited, to the benefit of both the policyholder and the insurance company. The above mentioned benefits create a win-win situation for both insurers and honest policyholders by driving down the cases of insurance fraud, hence reducing fraud losses, hence lowering premiums.

In some embodiments, a policyholder sends their ERD 200 device or evidence media files to a personal attorney, insurance agent, broker, or the like professional representative. The representative uses an online service to verify the evidence media files stored on ERD 200. The service may provide confirmation that the evidence media files were produced by a certain device, and with a certain timestamp, location, and the like. The service may further establish that the information is complete and has not been altered. Such service may be based on remote servers, for example over the Internet. The remote server may perform operations such as accepting the image, extracting data from the image file, extracting a unique identifier and/or hash codes as well an additional data, and executing one or more algorithms with security attributes that are designed to verify authenticity and/or integrity.

In some embodiments, the insurer's business process requires physically inspecting an ERD 200 to verify it has not been tampered with. Therefore, it is eventually delivered physically to the insurance company, for example by a postal service. In some embodiments though, the policyholder does not send the device to the insurance company. In some embodiments, this requirement is only for claims over a certain monetary value or in the case of bodily injuries. In some embodiments, the insurer begins processing of information by receiving information from ERD 200 over the Internet, but finalizes the payment to the policyholder only upon receiving and inspecting the device physically.

The following is an example of how ERD 200 and EMS 1100 are integrated into an auto insurance business process. Immediately following an auto accident, a policyholder calls the insurer's customer service and notifies the insurer's customer service agent about the accident. The policyholder also informs the agent that he has taken pictures using ERD 200 provided by the insurer. In some embodiments, the agent advises the policyholder to take a few more shots of various visual elements at the accident scene.

Once at home, the policyholder contacts customer service again on the phone for assistance with transferring information from ERD 200 to the insurer's datacenter. After plugging ERD 200 into an online PC, a program or website with the insurer's logo is launched. This program is part of EMS 1100.

The policyholder clicks on an option such as “prepare data to be sent to the insurer”. The program presents a guided sequence of screens and options that follow a business process as defined by the insurer. Thumbnails of the evidence media files are displayed and the policyholder categorizes each of them appropriately; some are damage recording, some are photos of documents, and the like. The policyholder then completes some online forms, for example ACORD standardized forms, with textual information regarding the accident, damages, third parties, witnesses, and the like. In some embodiments, certain fields in the form are prefilled—such as the insurance policy number and personal details, because these details are known to EMS 1100 following the transmission of unique identifier 206 from ERD 200 to the insurer's server.

Once the organization of evidence media files and the forms are completed, the data is transmitted to the remote system. The data is linked to the customer's insurance policy. As part of the process, the evidence media files are verified for integrity, authenticity, and completeness, as described in FIG. 10.

In some embodiments, where a policyholder does not complete a form, the partially filled form is stored in access controlled non-volatile memory 205 of ERD 200, in order to retain the policyholder form's state for a later time.

Various versions of EMS 1100 may exist, adapted to specific insurance companies, specific insurance policies, and other parameters. In some embodiments, the specific software configuration may be stored in the ERD 200 during its manufacturing, where specific information relevant to the service, such as which servers to connect to and what programs to invoke are stored. In some embodiments, the specific software configuration is received after the device is attached to an online PC and a preliminary connection with a default server is established. The default server identifies the device serial number and fetches the remaining pieces, procedures, screens, logos, and the like that are to be presented to an end user, from another server.

In some embodiments, the entire process of data logging and upload requires that ERD 200 is attached to the PC logged on to the remote service. In some embodiments, security authentication methods are employed to ensure that ERD 200 is indeed attached to the PC.

In some embodiments, a service provider such as an insurance company or a car rental company is interested in receiving certified data required for its business process, but not in dealing itself with the added complexity required to manage evidence recording devices. Therefore a more generalized description of the above would include an ERD management service. The management service performs tasks such as issuing devices to end-users, operating a call center with support for device usage, and employing EMS 1100 software for data transfer from devices and verification. In some embodiments, the management service handles the flow of information to and from an end user. The management service may distribute to end-users whatever information or procedures that are required by the respective service provider.

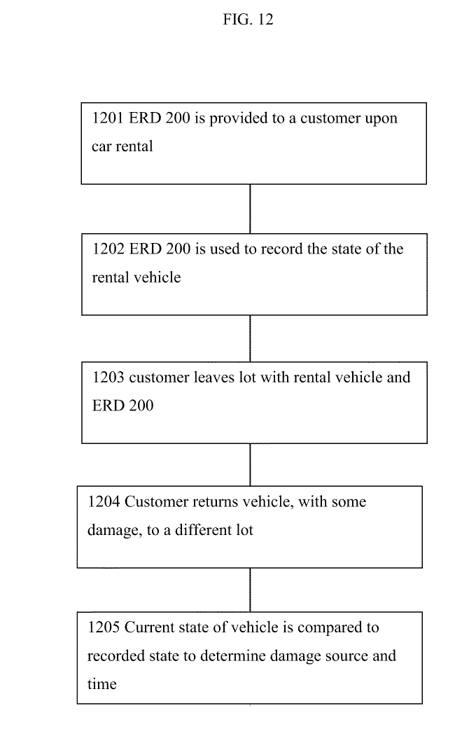

FIG. 12 is a flow chart of an exemplary method of utilizing an Evidence Recording Device in a car rental scenario. In step 1201, a customer is provided with an ERD 200 when renting a car. In step 1202, before leaving the rental lot, the customer uses ERD 200 to record the state of the car by photographing both the exterior and the interior of the vehicle. In some embodiments, the recording is performed together with a rental associate. In step 1203, the customer leaves the rental lot with the car and ERD 200. In some embodiments, the ERD 200 remains in the possession of the car rental lot. In step 1204, the customer returns the car to another rental lot and some damage is present. In step 1205, the damage is compared to the recorded status of the vehicle as captured by the customer at the onset of the rental period. The comparison helps the car rental firm to establish if the damage was already present when the car was rented or occurred during the rental period.

Accordingly, it is to be understood that the embodiments of the invention herein described are merely illustrative of the application of the principles of the invention. Reference herein to details of the illustrated embodiments is not intended to limit the scope of the claims, which themselves recite those features regarded as essential to the invention.

We claim:

1. An evidence recording device comprising:
a power source,
a data capture module configured to convert audio-visual information into a digital representation,
a controller,
data interface means, and
an access controlled non-volatile storage adapted to store a unique identifier and evidence management firmware, adapted to said record audio-visual information as evidence media files.

2. A device according to claim 1, further including: a shutter release button, that, when pressed, commands the controller to capture a digital still image.

3. A device according to claim 1, further including: a shutter release button, that, when pressed, commands the controller to capture a digital video clip.

4. A device according to claim 1, further including: a shutter release button, that, when pressed, commands the controller to capture an audio recording.

5. A device according to claim 1, further including: a shutter release button, that, when pressed, commands the controller to capture an audio recording a combination of still images, video, and audio.

6. A device according to claim 1, wherein the data capture module is triggered simultaneously with the triggering of an image capture by clicking a shutter button.

7. A device according to claim 1, wherein the data capture module is triggered by ambient noise above a threshold level within a certain period after the shutter button was pressed.

8. A method, comprising:
capturing visual information elements using an evidence recording device comprising a power source, human control means, data capture means, a controller, data interface means, and an access controlled non-volatile storage adapted to store a unique identifier and evidence management firmware, adapted to record audio-visual information elements to be stored as evidence media files,
transmitting one or more said evidence media files to a remote server, and
authenticating the transmitted evidence media files with reference to said unique identifier.

9. A system, comprising evidence management software and one or more evidence recording devices, each evidence recording device comprising a power source, human control means, data capture means, a controller, data interface means, and an access controlled non-volatile storage adapted to store a unique identifier and evidence management firmware, adapted to record audio-visual information elements to be stored as evidence media files, wherein said evidence management software is adopted to authenticate one or more said evidence media files.
